(19) United States
(12) Patent Application Publication
(10) Pub. No.: US 2016/0203278 A1
(43) Pub. Date: Jul. 14, 2016

(54) SYSTEM AND METHOD FOR FACILITATING MULTILATERAL MARKETPLACE FOR PRESENTING BIDS TO CONSUMERS

(71) Applicant: Joshua Philip Shoemaker, Shoreline, WA (US)

(72) Inventor: Joshua Philip Shoemaker, Shoreline, WA (US)

(73) Assignee: Shoemaker LLC, Shoreline, WA (US)

(21) Appl. No.: 14/972,697

(22) Filed: Dec. 17, 2015

Related U.S. Application Data
(60) Provisional application No. 62/103,351, filed on Jan. 14, 2015.

(51) Int. Cl. G06F 19/00; H04L 29/08; H04L 12/58

(52) U.S. Cl. CPC G06F 19/328; H04L 51/04; H04L 67/10

(57) ABSTRACT

A computer-related method and cloud-computing based system for facilitating relationships between providers of healthcare service, consumers of healthcare services, and payers of healthcare services using a healthcare disruption marketplace. The method involves one or more payers of healthcare services assembling data about consumers in a secure database. The payer may then choose to engage the marketplace whereby protocols are established to allow healthcare service providers access to the established data in the database. As various healthcare service providers choose to engage the marketplace, the service providers may offer bids at the marketplace to be accessed by consumers such that each consumer may choose amongst bids for healthcare services. Upon selection, the consumer's decision is assimilated within the marketplace and triggers establishing a pay relationship between the healthcare service provider and the payer.

### PRIORITY CLAIM

This patent application claims priority to U.S. Provisional Patent Application Ser. No. 62/103,351 entitled “MULTILATERAL MARKETPLACE FACILITATING SERVICE COMPANIES USING PAYER COMPANY DATA AND PRESENTING BIDS TO CONSUMERS”, filed on Jan. 14, 2015, which is incorporated by reference in its entirety.

### BACKGROUND

The healthcare industry and health care market is befuddled by numerous regulations, restrictions, and rules that lead to several inefficiencies on several levels. Currently, most established healthcare service companies and healthcare industry start-up companies sell their services directly to service providers of health plans or directly to employers that provide their own healthcare plans. This approach has led to hundreds of billions of dollars in waste known to exist within the healthcare industry. As a result, most healthcare service companies have no clear path to adequately engage individual consumers, provide pay platforms, or scale their offerings quickly to effectively improve quality and/or reduce costs in relation to work with individual consumers, while maintain high service quality for existing service providers of healthcare plans or self-insuring employers. Furthermore, in the current state of the healthcare industry, there is no effective way for healthcare service companies to directly bid for individual consumers who may wish to engage and work directly with a healthcare service provider.

Additionally, healthcare plan providers and self-insured employers have extreme difficulty selecting effective options from dozens of companies claiming to provide ways to reduce healthcare costs. As a result, health plan providers and self-insured employers end up risking higher fees and larger payments as a result of ill-fated decisions. Further yet, when healthcare service companies are selected, it is difficult to assign consumers to specific healthcare service companies and/or attribute savings to specific actions of one company over another. This is problematic for healthcare service companies and related entities who would benefit from a system that allows free movement between healthcare service companies and which accounts for specific savings.

Therefore, what is needed is a marketplace approach that leads to improved quality, lower healthcare costs, and a more profitable approach for healthcare service companies serving individual consumers by allowing the healthcare service companies, who are typically paid by self-insured employers or service providers of healthcare plans, to compete for individual consumers.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 is a diagram of a suitable computing environment for practicing various aspects and embodiments of the systems and methods of the subject matter disclosed herein;

FIG. 2 shows a block diagram of a healthcare disruption marketplace having the computing environments of FIG. 1 indicated as domain level abstractions of the various classes of computing environments according to an embodiment of the subject matter disclosed herein.

FIG. 3 shows a flow diagram of a method for facilitating relationships between the domains of FIG. 2 using the healthcare disruption marketplace according to an embodiment of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

As discussed briefly in the background above, under current market arrangements, healthcare service companies and healthcare service start-ups may choose to sell their services to self-insured employers and service providers of healthcare plans in an effort to alleviate waste in the healthcare industry. However, such healthcare service companies and healthcare service start-ups have no effective way to directly bid for individual consumers of healthcare services who may be interested in engaging in a direct business relationship. On reason for this inefficiency is that the payers of the healthcare service plans are often employers of the consumers that receive the healthcare service and exercise authority and control over the business relationship with healthcare plan service providers. Employers often wish to minimize the time and effort for providing healthcare to employees and therefore seek a path of least resistance by implementing a one-size-fits-all approach through one service provider of a small handful of healthcare plans. As a result, there is no marketplace for healthcare service companies and healthcare service startups to compete to serve and engage individual consumers.

The subject matter disclosed herein is related to a computer-related method and cloud-computing based system for facilitating relationships between providers of healthcare service, consumers of healthcare services, and payers of healthcare services using a healthcare disruption marketplace. The method involves one or more payers of healthcare services assembling data about consumers in a secure database. The payer may then choose to engage the marketplace whereby protocols are established to allow healthcare service providers access to the established data in the database. As various healthcare service providers choose to engage the marketplace, the service providers may retrieve data and analyze the data to determine bid levels and acceptance requirements to offer to consumers for healthcare services. The bids at the marketplace may then be accessed by consumers such that each consumer may choose amongst bids for healthcare services. Upon selection of one or more bids, the consumer's decision is assimilated within the marketplace and triggers a notification to the service provider and to the payer. Once notifications are sent, the payer and the provider may then establish a pay relationship such that the consumer may then use the services provided by the healthcare service provider.

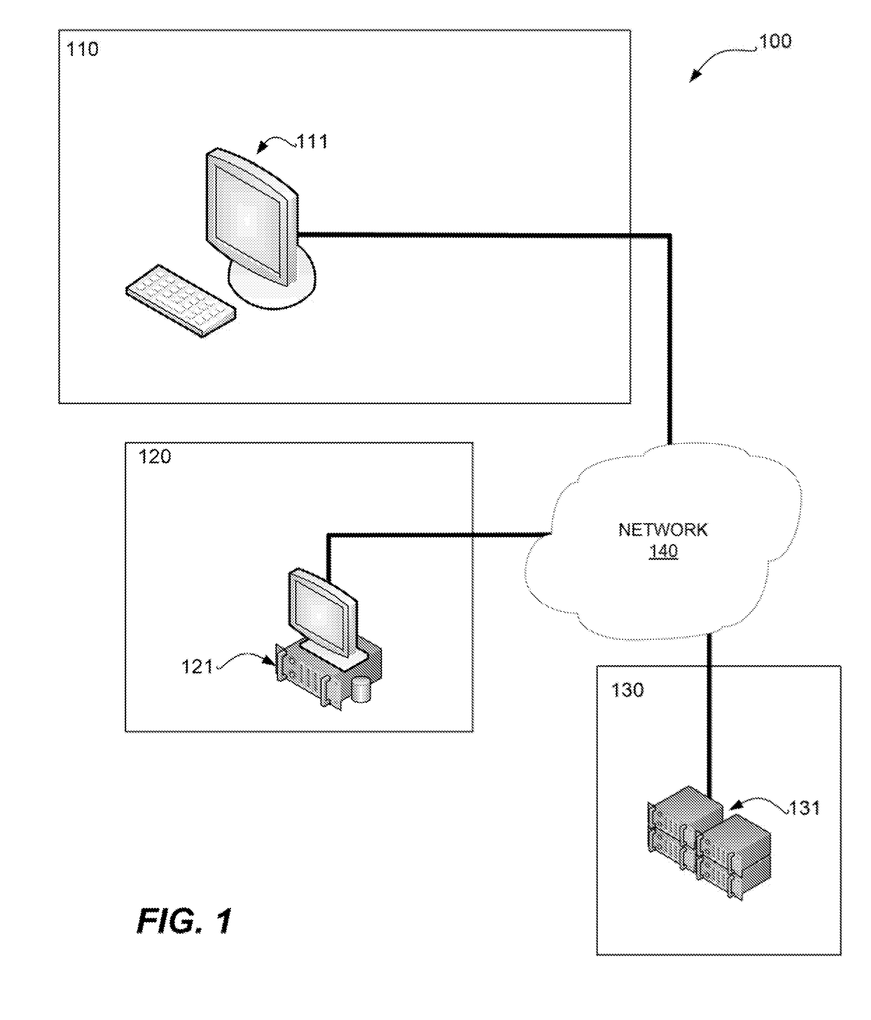

The multilateral marketplace provides several advantages over traditional healthcare markets. The systems and methods briefly discussed above establish a marketplace where multiple healthcare service providers can be introduced to consumers covered by payers and consumers can be paid (or given deep discounts) due to the potential profits service providers stand to gain by selecting and engaging with the healthcare service provider of their choice. The systems and methods briefly discussed above define accounts of payers and healthcare service providers who have reached shared-risk arrangements so the service providers are given the opportunity to submit bids for consumers who are covered by those payers. The systems and methods briefly discussed above utilize data from payers for the healthcare service providers to review and submit bids. The systems and methods briefly discussed above assign multiple bids to each consumer's account and display them for review and selection in a secure web-based environment or other secure manner. These and other advantages will become apparent in the discussion of the various embodiments regarding FIGS. 1-3 below.

FIG. 1 is a diagram of a suitable computing environment 100 for practicing various aspects and embodiments of the systems and methods of the subject matter disclosed herein. Among other things, the present subject matter may be embodied in whole or in part as a system, as one or more methods, or as one or more devices within the computing environment 100 as generally described with respect to FIG. 1. In some embodiments, the subject matter may be implemented in the context of a multi-tenant, “cloud” based environment (such as a multi-tenant business data processing platform), typically used to develop and provide web services and business applications for end users. Note that embodiments may also be implemented in the context of other computing or operational environments or systems, such as for an individual business data processing system, a private network used with a plurality of client terminals, a remote or on-site data processing system, another form of client-server architecture, and the like.

Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging. For the purposes of the detailed descriptions herein, these computing entities that may be embodied throughout a cloud computing environment will be described in terms of logical delineations between a consumer computing environment 110 having at least one healthcare service consumer device 111, a service provider computing environment 120 having at least one healthcare service provider device 121, and a payer computing environment 130 having at least one healthcare service payer computing device 131. Each of these computing environments 110, 120, and 130 may be communicatively coupled through a computer network 140, such as the Internet.

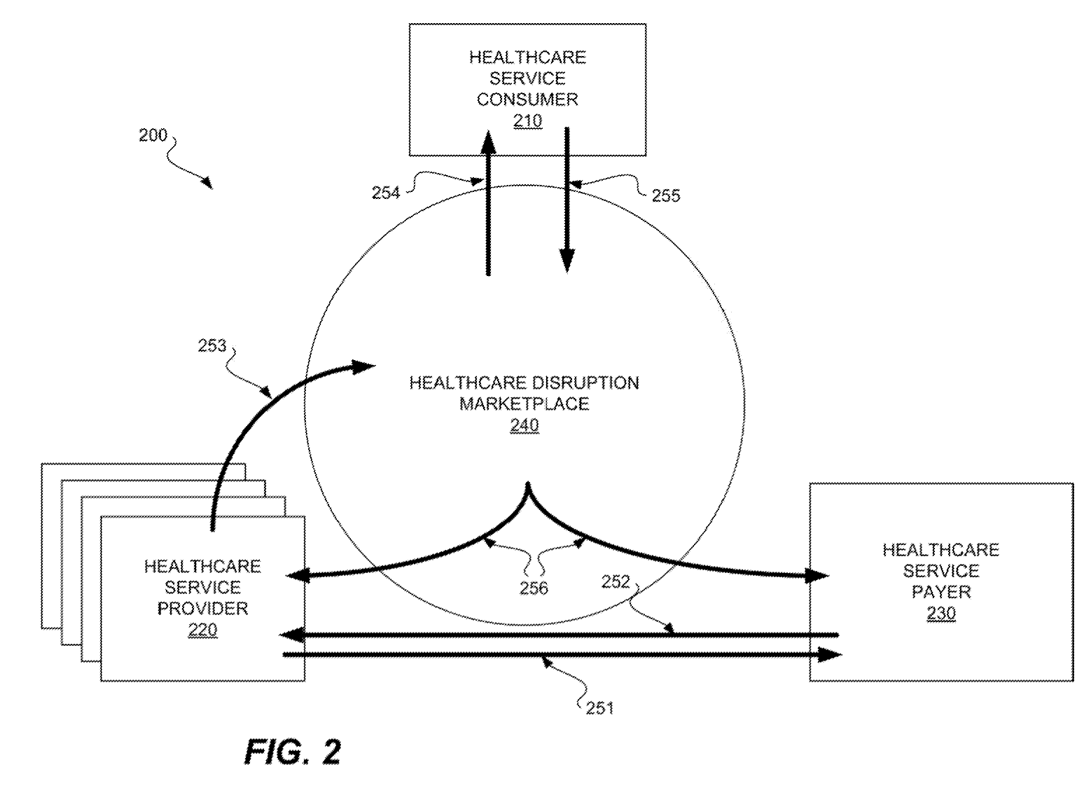

Embodiments may take the form of one or more hardware implemented embodiments, one or more software implemented embodiments, or embodiments combining software and hardware aspects. For example, in some embodiments, one or more of the operations, functions, processes, or methods described herein may be implemented by one or more suitable processing elements (such as a processor, microprocessor, CPU, controller, and the like) that are part of a client device, server, network element, or other form of computing or data processing device/platform and that is programmed with a set of executable instructions (e.g., software instructions), where the instructions may be stored in a suitable non-transitory data storage element. In some embodiments, one or more of the operations, functions, processes, or methods described herein may be implemented by a specialized form of hardware, such as a programmable gate array, application specific integrated circuit (ASIC), or the like. The various examples in this detailed description are, therefore, not to be taken in a limiting sense. Notwithstanding the many actual embodiments that may exist across the many computing platforms, the logical expressions of these platforms are shown next with respect to FIG. 2.

FIG. 2 shows a block diagram 200 of a healthcare disruption marketplace 240 (marketplace 240, hereinafter) having the computing environment of FIG. 1 indicated as domain level abstractions of the various delineations of entities according to an embodiment of the subject matter disclosed herein. The domain level abstractions include a healthcare service consumer domain 210 that corresponds to the consumer computer environment 110 of FIG. 1. This domain includes all consumers of healthcare services and is not necessarily restricted to employees of companies that provide healthcare service plans. That is, any consumer who may use healthcare services may be in this domain and can access the marketplace 240 via a consumer computing environment 110 (e.g., a laptop computer 111 connected to the Internet, as but one example).

Further, the domain level abstractions also include a healthcare service provider domain 220 that corresponds to the service provider computer environment 120 of FIG. 1. This domain includes all providers of healthcare services (e.g., doctors, hospitals, clinics, pharmacies) and is not necessarily restricted to companies that provide direct healthcare services. That is, additional companies that also provide products support for the healthcare industry may be in this domain (e.g., makers of software for doctor billing and timekeeping, makers of uniforms for healthcare workers, and the like) and can access the marketplace 240 via a service provider computing environment 120 (e.g., a computer 121 connected to the Internet, as but one example).

Further yet, the domain level abstractions include a healthcare service payer domain 230 that corresponds to the payer computer environment 130 of FIG. 1. This domain includes all payers of healthcare services and is not necessarily restricted to healthcare service plan providers most often associated with insurance companies. That is, any company that may pay for healthcare services on behalf of another person (such as a self-insured employer or a government entity like the Veterans Administration) may be in this domain and can access the marketplace 240 via a payer computing environment 130 (e.g., a computer 131 connected to the Internet, as but one example).

Embodiments of the subject matter described herein solve inefficiencies and lack of access to healthcare services by consumers through the creation of a multilateral marketplace 240 that can serve to provide access and communications directly between the service provider domain 220 and the consumer domain 210 by using data from the payer domain 230. In one embodiment, the consumers in the consumer domain may already have a contractual relationship with payers in the payer domain. That is, a typical health care insurance policy may have already been established between one or more customer and a health care insurance company. The marketplace may then be used to create and submit bids to individual consumers or groups of consumers in the consumer domain 210 for providing healthcare services to serve them from service providers in the service provider domain 220. Such provision of services may be exclusive or non-exclusive.

The embodiments described in this specification differ from and improve upon currently existing options in existing healthcare markets. In particular, one advantage includes offering a new business model that standardizes and facilitates risk-sharing arrangements between payers and healthcare service providers. This, in turn, allows risk-taking healthcare service providers to utilize data about consumers to submit bids directly to consumers for providing exclusive healthcare services through the consumer's payer (healthcare plan/self-insured employer). Furthermore, one or more these embodiments improve upon conventional healthcare marketplace options because, currently, consumers are given little or no choice as to which healthcare service provider will serve them and are not given effective financial incentives in the form of bids so they can choose the healthcare service provider that suits their needs and desires or payment arrangement that works for them. These advantages are manifested in addition to or in lieu of customers having no traditional network access. A customer's health plan design (that typically includes deductible, co-pays, and the like) and access to network/choice of healthcare service providers will not change. That is, the number of healthcare service providers in which a consumer may engage remains at least as much as the conventional marketplace. One or more embodiments of the multilateral healthcare marketplace overcomes these problems through facilitating and standardizing the risk-taking arrangements between payers and healthcare service providers such that standard data points may be shared and used to determine how bid pricing to the consumer. These advantages lead to improved service quality, lower costs, and improved profit margin for healthcare service providers.

Turning focus back to FIG. 2, several steps may be undertaken in order to facilitate the relationships between the different domains utilizing the marketplace 240. The steps and/or elements of various methods described below are intended to be exemplary only and it is not intended to limit the scope of the multilateral marketplace 240. As such, the steps and/or elements of various methods may be realized in a cloud computing environment using computer-implemented method steps that involve electronic communications between computing entities. Often, these computing entities may be under the control of a human user making human decisions about how to improve efficiencies in the marketplace 240. As a result, the various methods and systems described herein provide a tool by which human actors may more efficiently and effectively accomplish tasks within the context of the multilateral marketplace 240. Persons having ordinary skill in the art relevant to the present disclosure may understand there to be equivalent elements that may be substituted within the present disclosure without changing the essential function or operation of the multilateral marketplace 240.

As a preliminary step, underlying data about consumers may be assembled and established in the payer domain 230. This step establishes data in a database about at least one consumer of healthcare services, but often many. This data is assembled by entities that typically collect and analyze such data in the first place, namely the various payers of healthcare services that have a relationship with the consumers. This data may typically include health history data of the consumer; health insurance coverage history data about the consumer, credit history data of the consumer; demographic data about the consumer; genetic data about the consumer; family history data about the consumer, health code data about past healthcare services received by the consumer, health risk score data about the consumer, quality of past healthcare data about the consumer, gaps in past healthcare data about the consumer, and employment history data of the consumer. Once the data exists in an accessible database in the payer domain 230, the marketplace 240 may be in readiness to facilitate the bidding process as discussed next.

As a first step 251, healthcare service providers from the service provider domain 220 may choose to engage the marketplace 240 by requesting access to the data about consumers held by payers in the payer domain. Thus, a particular healthcare service provider may request access to the database of consumer data in the payer domain at step 251. The payer in the payer domain 230 may then grant access to the data in the database to the provider of healthcare services. At step 252, the healthcare service provider retrieves data necessary to formulate a bidding strategy for enticing one or more consumers to engage with their services. As the underlying data may be sensitive health records of individuals, all granted access and data transfers are in compliance with the Health Insurance Portability and Accountability Act.

Once the healthcare service provider formulates a bidding strategy based upon an analysis of the retrieved data, the health care service provider may electronically communicate a bid to the marketplace 240 at step 253. As the one or more consumers may engage the marketplace 240, this bid, and perhaps many others are received from other bidding healthcare service providers as an offer to provide healthcare services to meet the consumers' healthcare service needs.

The bids from the healthcare service providers may also include certain requirements for coverage. These so-called engagement requirements are specific performance duties placed upon consumers as a condition of accepting a bid provided by a provider or healthcare services. Such engagement requirements may include a promise to commit to weekly doctor visits, join health club, agree to begin medication, and the like. When bids are for a group of consumers, the bids may include the engagement requirements for all consumers in the group of consumers or may include at least a threshold number of consumers to accept the engagement requirements. All bids from all healthcare service providers are assembled and organized within the context of the marketplace 240.

The marketplace 240 may be its own computing environment through which actors in the other domains may choose to engage and interact. Thus, the computing environment may have an interface whereby individuals may browse to a web-based graphic user interface (GUI) that is accessible by consumers and healthcare service providers. Healthcare service providers may use the GUI to upload, organize and review bids that are placed in the marketplace. Consumers may use the GUI to review bids placed to entice them to engage in services with a bidding service providers. In other embodiments, the bids may be electronically communicated to consumers (such as through e-mail) thereby enabling the individual consumers to review bids without having to browse to a GUI for the marketplace. In any embodiment, the bids assembled are in the marketplace 240 in a secure manner (e.g., only accessible by the consumer(s) to which the bid apples) and may be securely communicated to the consumer at step 254 (e.g., via encrypted email or the like).

Once bids are reviewed by individual consumers or groups of consumers, the consumer(s) may then choose a particular bid via their personal review process. This selection may be accomplished through interacting with the GUI of the marketplace 240 or through another electronic communication (e.g., reply to bids email). In any embodiment, the consumer selection of a bid is securely communicated to the marketplace 240 at step 255.

Once an acceptance of a bid is received at the marketplace 240, the marketplace automatically establishes a pay relationship between the payer of healthcare services and the provider of healthcare services. This is facilitated at step 256 by communicating the acceptance of the bid to the payer in the payer domain 230 while also communicating the acceptance of the bid to the healthcare service provider in the service provider domain 220. The facilitation may include handling deductible provisions, co-pay provisions, automatic code billing, special arrangements billing, and the like. If the consumer or the service provider chooses to end the healthcare service arrangement, the pay relationship may be terminated and the process may start over with updated data about the consumer being reposted to the database accessible by healthcare service providers wishing to provide new bids for services.

In FIG. 2, the domain level abstractions 210, 220, and 230 may also be computing environments in the context of a cloud-computing system. Thus, in one embodiment, a cloud-based computing environment may be configured to establish the payer-provided consumer data in a database (e.g., a means for establishing data in a database). The computing environment hosting the database may further include a credential module or data security module configured to grant access to the data in the database to healthcare service providers seeking to provide bids (e.g., a means for granting access to the database). In this manner, the overall marketplace 240 may be established as a cloud-based computing environment for facilitating matching consumers to providers for healthcare services. In such a cloud-based computing environment, one or more processors may be used to control one or more communication modules for facilitating electronic communications between the various domains of FIG. 2 (e.g., a means for receiving bids, electronically communicating bids to consumers, and for electronically receiving one or more acceptances of bids from one or more consumers). In this sense, an electronic communication interface may be configured to electronically communicate service care bids to consumers and may be configured to electronically receive one or more acceptances of bids from one or more consumers. The cloud-based computing environment may further include a financial transaction module configured to establish a pay relationship between the payer of healthcare services and a corresponding provider of healthcare services with respect to each consumer's acceptance of a respective bid (e.g., a means for establishing a pay relationship).

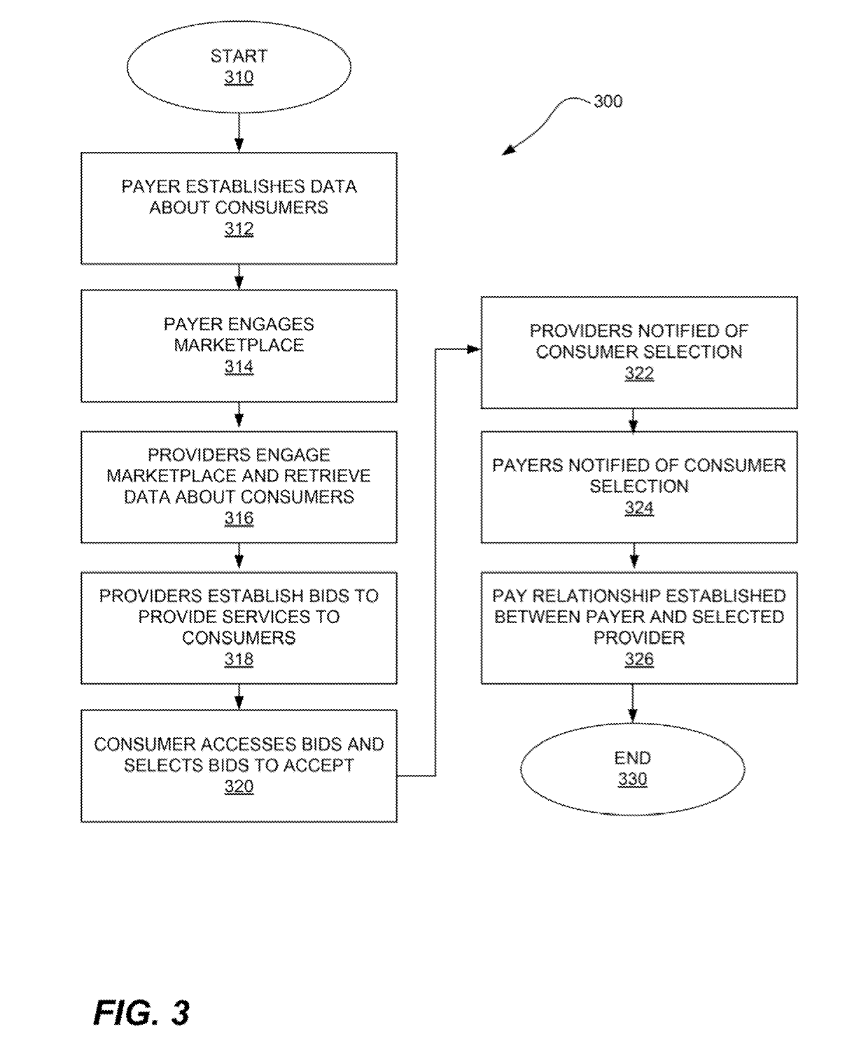

In FIG. 2, each domain 210, 220, and 230, may include one or more personal computers configured to communicatively communicate with the cloud-based marketplace 240. In this sense, various actors within these domains may follow a method for using the marketplace 240 as discussed next with respect to FIG. 3.

FIG. 3 shows a flow diagram 300 of a method for facilitating relationships between the domains of FIG. 2 using the healthcare disruption marketplace 240 according to an embodiment of the subject matter disclosed herein. The method may begin at step 310. At step 312, one or more payers of healthcare services will have various data points about several consumers that may be established in a secure database. The payer may then choose to engage the marketplace at step 314 whereby protocols are established to allow healthcare service providers access to the established data in the database.

As various healthcare service providers choose to engage the marketplace, the service providers may retrieve data, at step 316, from the secure database established by the payer. Once data has been retrieved, the healthcare service providers may analyze the data to determine bid levels and acceptance requirements to offer to consumers for healthcare services. Once bids are determined, the healthcare service providers may then upload the bids to the marketplace at step 318. The bids at the marketplace may then be accessed by consumers at step 320 such that each consumer may choose amongst bids for healthcare services. Upon selection of one or more bids, the consumer's decision is assimilated within the marketplace. This triggers a notification to the service provider at step 322 and a notification to the payer at step 324.

Once notifications are sent, the payer and the provider may then establish a pay relationship such that the consumer may then use the services provided by the healthcare service provider at step 326. The method may then end at step 330. If the pay relationship is terminated, the entire method may be repeated such that the consumer may then seek services from bidding service providers.

The multilateral marketplace generally takes advantage of the steps discussed above (i) to establish a marketplace where multiple healthcare service providers can be introduced to consumers covered by payers wherein consumers can be paid part of the potential profits or given greatly reduced costs to select and engage with the healthcare service providers that they choose, (ii) to define accounts of payers and healthcare service providers who have reached shared-risk arrangements so the service providers are given the opportunity to submit bids for consumers who are covered by those payers, (iii) to utilize data from payers for the healthcare service providers to review and submit bids, and (iv) to assign multiple bids to each consumer's account and display them for review and selection in a secure web-based environment. These steps/elements work together to uniquely align participants and incentives in the marketplace. Additional steps/elements may include sub-populations or expanded services that can be assimilated into the marketplace platform.

The aforementioned steps may be re-configured in any of several manners. The following five example reconfigurations demonstrate how the steps can be reconfigured: (1) segment specific populations of people with specific diseases (e.g., diabetes, heart disease, cancer), hospitalizations, acute care events or any other healthcare sub-population; (2) allow consumers to accept more than one bid or for more than one healthcare service provider to jointly submit a bid; (3) allow individuals to submit their own healthcare claims data and related information and request that healthcare service providers bid to serve them as individuals; (4) be used as a sales platform to sell healthcare services to customers instead of bidding for the right to exclusively serve them; and (5) segment specific populations of people with specific circumstances such as employees needing worker's compensation, employees needing short-term disability coverage, and the like.

To use the multilateral marketplace as a payer, the payer may (i) quickly reach shared risk arrangements with many healthcare service providers, (ii) make consumer data assembled by the payer available to healthcare service providers to measure potential savings for each consumer, and thereby (iii) improve quality and lower costs of healthcare services because consumers engage with the healthcare service provider of their choosing.

To use the multilateral marketplace as a healthcare company, the healthcare service provider could (i) sell services directly to consumers whose coverages are provided by third-party payers and (ii) scale healthcare solutions by quickly gaining consumers through the marketplace.

To use the multilateral marketplace as a consumer, the consumer could (i) review bids from healthcare service provider, (ii) select the right incentive and program offered by a healthcare service provider that works for the consumer, and thereby (iii) experience improved health and lower overall costs of healthcare from the services provided by a healthcare service provider and paid for by their health plan or employer.

Additionally, while the multilateral marketplace focuses on creating a multilateral marketplace for the healthcare industry, some embodiments of the multilateral marketplace could be implemented to serve other industries, specifically, any industry in which there are three parties involved (bill payer, one who is seeking to provide services differently than the current environment, and a consumer) could use this marketplace.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A computer-implemented method, comprising:
establishing data in a database about at least one consumer of healthcare services, the data provided by a payer of healthcare services having a relationship with the at least one consumer;
granting access to the data in the database to at least one provider of healthcare services;
receiving at least one bid to provide healthcare services to the at least one consumer based on the data, the bid received from the at least one provider of healthcare services;
electronically communicating the at least one bid to the at least one consumer;
electronically receiving an acceptance of the bid by the consumer; and
in response to the acceptance of the bid, establishing a pay relationship between the payer of healthcare services and the provider of healthcare services.

2. The computer-implemented method of claim 1, wherein the establishing data further comprises assembling one or more from the group comprised of: health history data of the consumer; health insurance coverage history data about the consumer, credit history data of the consumer; demographic data about the consumer; genetic data about the consumer; family history data about the consumer, health code data about past healthcare services received by the consumer, health risk score data about the consumer, quality of past healthcare data about the consumer, gaps in past healthcare data about the consumer, and employment history data of the consumer.

3. The computer-implemented method of claim 1, wherein granting access further comprises providing data about the at least one consumer in compliance with the Health Insurance Portability and Accountability Act.

4. The computer-implemented method of claim 1, wherein receiving the at least one bid further comprises receiving a plurality of bids from a plurality of healthcare services providers, each bid based upon the data accessed in the database.

5. The computer-implemented method of claim 1, wherein electronically communicating and electronically receiving comprises a web-based graphic user interface accessible by the at least one consumer and accessible by the at least one healthcare service provider.

6. The computer-implemented method of claim 1, wherein electronically communicating and electronically receiving comprises a electronic mail.

7. The computer-implemented method of claim 1, further comprising requiring engagement requirements by the consumer as a condition of accepting a bid provided by a provider or healthcare services.

8. The computer-implemented method of claim 7, wherein at least one engagement requirement comprises requiring at least a plurality of similarly-situated consumers to accept the bid.

9. The computer-implemented method of claim 1, further comprising:
removing the data from the database after the pay relationship is established;
dissolving the pay relationship at a later time; and
reposting the data to the database after the pay relationship is dissolved.

10. A computer system, comprising:
a cloud-based computing environment configured to establish data in a database about a plurality of consumers of healthcare services, the data provided by a payer of healthcare services;
a module configured to grant access to the data in the database to a plurality of providers of healthcare services;
wherein the cloud-based computing environment is configured for receiving a plurality of bids to provide healthcare services to the plurality of consumers based on the data, the bids received from the plurality of providers of healthcare services;
an electronic communication interface configured to electronically communicate the plurality of bids to the plurality of consumers and configured to electronically receive one or more acceptances of bids from one or more consumers; and
a financial transaction module configured to establishing a pay relationship between the payer of healthcare services and a corresponding provider of healthcare services with respect to each consumer's acceptance of a respective bid provided by a respective provider of healthcare services.

11. The computer system of claim 10, wherein the established data further comprises one or more from the group comprised of: health history data of a consumer; health insurance coverage history data about a consumer, credit history data of a consumer; demographic data about a consumer; genetic data about a consumer; family history data about a consumer, health code data about past healthcare services received by a consumer, health risk score data about a consumer, quality of past healthcare data about a consumer, gaps in past healthcare data about a consumer, and employment history data of a consumer.

12. The computer system of claim 10, wherein access to the database is granted in compliance with the Health Insurance Portability and Accountability Act.

13. The computer system of claim 10, further comprising a web-based graphic user interface configured to present the data from the database to the plurality of consumers and to the plurality healthcare service providers.

14. The computer system of claim 10, wherein at least one bid in the plurality of bids further comprises engagement requirements by the consumer as a condition of accepting a bid provided by a provider or healthcare services.

15. The computer system of claim 14, wherein at least one engagement requirement comprises requiring at least a plurality of similarly-situated consumers to accept the bid.

16. The computer system of claim 10, further comprising a plurality of personal computers associated respectively with one of each of the plurality of consumers, the plurality of personal computers configured to communicate with the cloud computing environment hosting the database.

17. The computer system of claim 10, further comprising a plurality of personal computers associated respectively with one of each of the plurality of providers, the plurality of personal computers configured to communicate with the cloud computing environment hosting the database.

18. The computer system of claim 10, wherein at least one bid further comprises a bid to a group of consumers within the plurality of consumers.

19. A multilateral healthcare service marketplace, comprising:
a means for establishing data in a database about a plurality of consumers of healthcare services, the data provided by a payer of healthcare services;
a means for granting access to the data in the database to a plurality of providers of healthcare services;
a means for receiving a plurality of bids to provide healthcare services to the plurality of consumers based on the data, the bids received from the plurality of providers of healthcare services;
a means for an electronically communicating the plurality of bids to the plurality of consumers and for electronically receiving one or more acceptances of bids from one or more consumers; and
a means for establishing a pay relationship between the payer of healthcare services and a corresponding provider of healthcare services with respect to each consumer's acceptance of a respective bid provided by a respective provider of healthcare services.
